(19) United States
(12) Patent Application Publication
(10) Pub. No.: US 2024/0106273 A1
(43) Pub. Date: Mar. 28, 2024

(54) CHARGING BASE, MOBILE TERMINAL AND CHARGING SYSTEM

(71) Applicant: Huizhou TCL Cloud Internet Corporation Technology Co., Ltd., Huizhou (CN)

(72) Inventors: Wei CHEN, Huizhou (CN); Song BAI, Huizhou (CN); Zhishun LONG, Huizhou (CN)

(73) Assignee: Huizhou TCL Cloud Internet Corporation Technology Co., Ltd., Huizhou (CN)

(21) Appl. No.: 18/519,089

(22) Filed: Nov. 27, 2023

Related U.S. Application Data
(63) Continuation of application No. PCT/CN2022/077950, filed on Feb. 25, 2022.

(30) Foreign Application Priority Data
May 27, 2021 (CN) 202110583069.1

(51) Int. Cl. H02J 50/00; H02J 7/00; H02J 50/10

(52) U.S. Cl. CPC H02J 50/005; H02J 7/0044; H02J 50/10

(57) ABSTRACT

A charging base, a mobile terminal, and a charging system is provided. The charging base includes a power supply and a charging plate. The charging plate includes a metal housing; and multiple connecting units all provided within the metal housing and connected to the metal housing. Each of the multiple connecting units includes: an accommodating lattice made of an insulating material, provided within and connected to the metal housing; and a dividing part provided within the accommodating lattice. The dividing part divides the accommodating lattice into a first accommodating region and a second accommodating region. A first magnetic material is provided within the first accommodating region, and is electrically connected to the first electrode of the power supply. A second magnetic material is provided within the second accommodating region, and is electrically connected to the second electrode of the power supply.

### CROSS-REFERENCE

This application is a continuation application of International Application No. PCT/CN2022/077950, filed on Feb. 25, 2022, which claims priority to Chinese Application No. 202110583069.1, filed on May 27, 2021, both of which are incorporated by reference herein.

### FIELD

The present disclosure generally relates to the field of charging technology, and in particular to a charging base, a mobile terminal, and a charging system.

### BACKGROUND

With the development of science and technology, the application of wireless charging technology is more and more widespread. For example, wireless charging to a mobile terminal is generally realized by magnetic induction. That is, there is a coil within the charging base and the mobile terminal respectively. The principle is that electricity generates magnetism, and then magnetism converts to electricity. Much energy consumption in the middle causes an unsatisfactory charging efficiency. At the same time, in order to charge effectively, the coil of the mobile terminal needs to be aligned with the coil within the charging base during charging. In an actual use process, there will be a deviation between the coil of the mobile terminal and the coil within the charging base during the alignment process, whereby the magnetic flux cannot be effectively transmitted, thereby greatly reducing the charging efficiency.

### SUMMARY

The present disclosure achieves an object of providing a charging base, a mobile terminal, and a charging system, solving a technical problem that the effective charging efficiency of a magnetic induction wireless charging mode employed in existing art is low.

In order to achieve the above object, a technical solution adopted by the present disclosure is following.

According to an embodiment of the present disclosure, a charging base includes a power supply and a charging plate. The charging plate includes a metal housing; and multiple connecting units all provided within the metal housing and connected to the metal housing. Each of the plurality of connecting units includes: an accommodating lattice made of an insulating material, provided within and connected to the metal housing; and a dividing part provided within the accommodating lattice. The dividing part divides the accommodating lattice into a first accommodating region and a second accommodating region. A first magnetic material is provided within the first accommodating region. The first accommodating region and the first magnetic material define a first connecting subunit. The first magnetic material is regularly arranged under an action of the external first magnetic field to form a conductor. The first magnetic material is electrically connected to the first electrode of the power supply. A second magnetic material is provided within the second accommodating region. The second accommodating region and the second magnetic material define a second connecting subunit. The second magnetic material is regularly arranged under an action of the external second magnetic field to form a conductor. The second magnetic material is electrically connected to the second electrode of the power supply.

According to the charging base described above, the metal housing is made of iron or stainless steel.

According to the charging base described above, a diameter of a circumferential circle of the connecting unit is 1-3 mm.

According to the charging base, the multiple connecting units are arranged throughout the metal housing, and a first gap is provided between adjacent connecting units.

According to the charging base described above, a width of the first gap is 0.3-1 mm.

According to an embodiment of the present disclosure, a mobile terminal includes: a battery cover; a first power supply interface made of a magnetic material, electrically connected to the battery cover, capable of generating a first magnetic field; and a second power supply interface made of a magnetic material, electrically connected to the battery cover, capable of generating a second magnetic field.

According to the mobile terminal described above, a range value of a diameter of the first power interface is 5-7 mm; and/or, a range value of a diameter of the second power interface is 5-7 mm.

According to the mobile terminal described above, the diameter of the first power supply interface is 5 mm; and the diameter of the second power interface is 5 mm.

According to the mobile terminal described above, the first power supply interface and the second power supply interface are both provided in middle of the battery cover, and a second gap is provided between the first power supply interface and the second power supply interface.

According to the mobile terminal described above, the second gap is 8 to 12 times the diameter of the first power supply interface or the second power supply interface.

According to the mobile terminal described above, the second gap is 10 times the diameter of the first power supply interface or the second power supply interface.

According to an embodiment of the present disclosure, a charging system includes a mobile terminal and a charging base. The mobile terminal includes a battery cover; a first power supply interface made of a magnetic material; and a second power interface made of a magnetic material. The first power supply interface is electrically connected to the battery cover, and is capable of generating a first magnetic field. The second power interface is electrically connected to the battery cover, and is capable of generating a second magnetic field. The charging base includes a power supply and a charging plate. The charging plate includes a metal housing; and a plurality of connecting units all provided within the metal housing and connected to the metal housing. Each of the plurality of connecting units includes an accommodating lattice made of an insulating material, and a dividing part. The accommodating lattice is provided within and connected to the metal housing. The dividing part is provided within the accommodating lattice and divides the accommodating lattice into a first accommodating region and a second accommodating region. A first magnetic material is provided within the first accommodating region. The first accommodating region and the first magnetic material define a first connecting subunit. The first magnetic material is regularly arranged under an action of the external first magnetic field to form a conductor. The first magnetic material is electrically connected to the first electrode of the power supply. A second magnetic material is provided within the second accommodating region. The second accommodating region and the second magnetic material define a second connecting subunit. The second magnetic material is regularly arranged under an action of the external second magnetic field to form a conductor. The second magnetic material is electrically connected to the second electrode of the power supply.

According to the charging system described above, a size of the first power supply interface is larger than a size of the connecting unit; and/or a size of the second power interface is larger than the size of the connecting unit.

According to the charging system described above, a range value of a diameter of the first power supply interface is 5-7 mm; and/or a range value of a diameter of the second power interface is 5-7 mm.

According to the charging system, at least one of the first connecting subunits is in contact electrical connection with the first power interface; and/or at least one of the second connecting subunits is in contact electrical connection with the second power interface.

An advantageous effect achieved by the charging base, the mobile terminal, and the charging system according to the present disclosure is at least as follows.

(1) according to an embodiment, the charging base, the mobile terminal and the charging system use a conductor-to-conductor contact electrical connection to directly transmit current, in order to achieve charging of mobile terminals by the charging base, reducing energy consumption, improving the efficiency of charging of mobile terminals by the charging base, and improving charging speed, thus improving the user experience.

(2) according to the charging base, the mobile terminal and the charging system according to an embodiment, the mobile terminal may be placed at any connecting unit on the charging base, so as to implement effective charging of the mobile terminal by the charging base. The operation is convenient, and the charging efficiency is improved, thus improving the use experience of users.

(3) according to an embodiment, the charging base, the mobile terminal, and the charging system are simple in overall structure, convenient to charge, and low in cost.

### DESCRIPTION OF DRAWINGS

In order to describe the technical solution in embodiments of the present disclosure more clearly, the accompanying drawings required for use in description of embodiments or existing art will be briefly described below. It is apparent that the accompanying drawings in the following description are merely some embodiments of the present disclosure. For those skilled in the art, other drawings may be obtained according to these accompanying drawings without involving any inventive effort.

FIG. 1 is a structural schematic diagram of a mobile terminal placed on a charging base according to an embodiment of the present disclosure.

FIG. 2 is a structural schematic diagram of another perspective view of a mobile terminal placed on a charging base according to an embodiment of the present disclosure.

FIG. 3 is a structural schematic diagram of a mobile terminal according to an embodiment of the present disclosure.

FIG. 4 is a structural schematic diagram of a charging plate included in a charging base according to an embodiment of the present disclosure.

FIG. 5 is a structural schematic diagram of a charging base not charging a mobile terminal according to an embodiment of the present disclosure.

FIG. 6 is an enlarged structural schematic diagram of part A in FIG. 4.

FIG. 7 is a schematic structural diagram of charging a mobile terminal by a charging base according to an embodiment of the present disclosure;

FIG. 8 is a schematic structural diagram of a connecting unit according to an embodiment of the present disclosure.

### NUMERAL REFERENCES IN THE DRAWINGS

| | |
|---|---|
| 10 | Mobile terminal |
| 11 | First power supply interface |
| 12 | Second power supply interface |
| 13 | Battery cover |
| 14 | Second gap |
| 20 | Charging base |
| 21 | Power supply |
| 211 | First electrode |
| 212 | Second electrode |
| 22 | Charging plate |
| 221 | Metal housing |
| 222 | Connecting unit |
| 2221 | First connecting subunit |
| 2222 | Second connecting subunit |
| 2223 | Accommodating lattice |
| 22231 | First accommodating region |
| 22232 | Second accommodating region |
| 2224 | Dividing part |
| 2225 | First magnetic material |
| 2226 | Second magnetic material |

### DETAILED DESCRIPTION

In order to make the technical problems to be solved by the present disclosure, technical solutions, and advantages more clear, the present disclosure will be described in further detail below with reference to the accompanying drawings and embodiments. It should be understood that the specific embodiments described herein are merely illustrative of the present disclosure and are not intended to limit the present disclosure.

It should be stated that when a component is referred to as being “fixed to” “provided on” another component, it could be directly or indirectly located on the other component. When a component is referred to as being “connected to” another component, it may be directly or indirectly connected to the other component. Orientations or positions indicated by terms “up”, “low”, “left”, “right”, “front”, “rear”, “vertical”, “horizontal”, “top”, “bottom”, “inner”, “outer”, etc. are based on orientations or positions shown in the drawings, and are for convenience of description only and are not to be construed as limiting the technical solution. The terms “first” and “second” are used for descriptive purposes only, and are not to be construed to indicate or imply relative importance or to implicitly indicate the number of technical features. The meaning of “multiple” refers to two or more unless definitively and particularly specified otherwise.

### A First Example

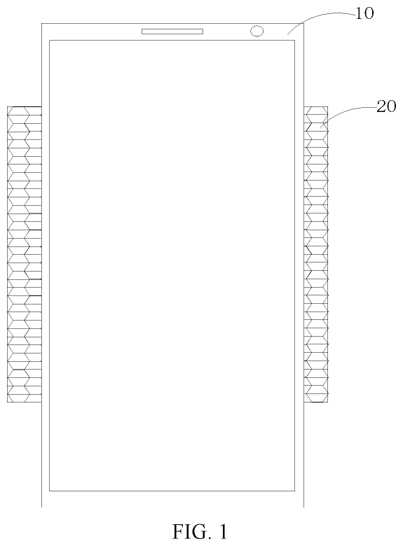

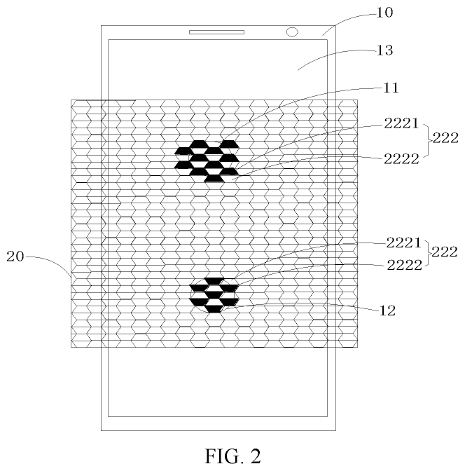

Referring to FIG. 1 and FIG. 2, according to an embodiment, a charging system includes a mobile terminal 10 and a charging base 20.

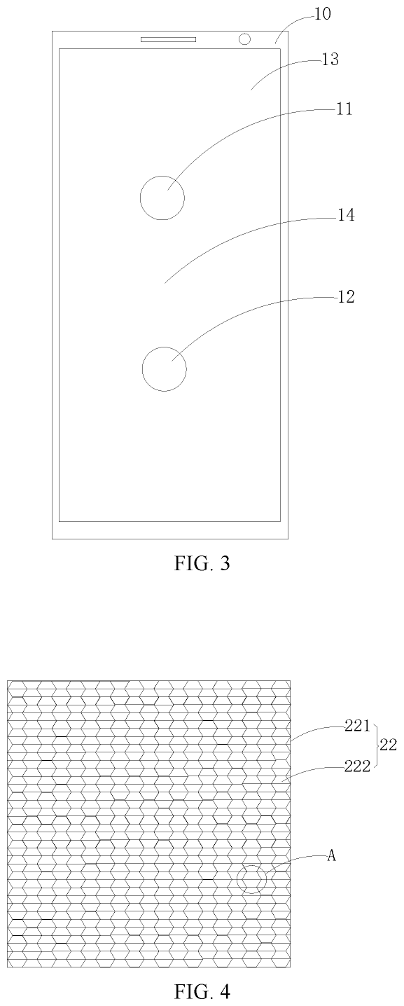

Referring to FIG. 3, the mobile terminal 10 includes a battery cover 13; a first power supply interface 11 made of a magnetic material, electrically connected to the battery cover 13, and capable of generating a first magnetic field; and a second power supply interface 12 made of a magnetic material, electrically connected to said battery cover 13, and capable of generating a second magnetic field.

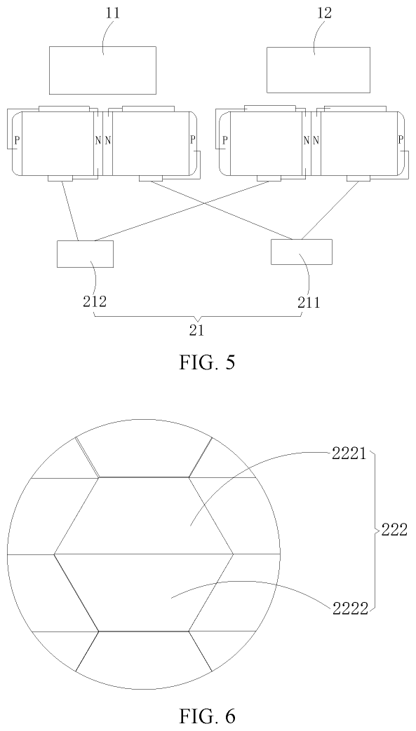

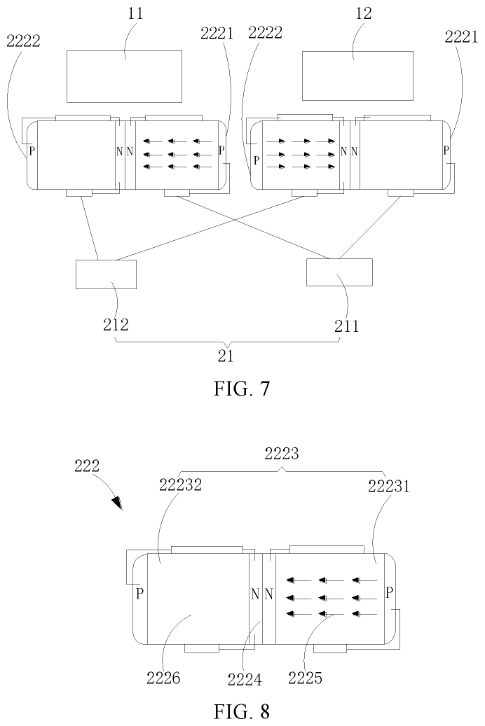

Referring to FIG. 4 and FIG. 5, the charging base 20 includes a power supply 21 and a charging plate 22. Referring to FIG. 4, the charging plate 22 includes a metal housing 221; and multiple connecting units 222. Multiple connecting units 222 are all provided within the metal housing 221 and connected to the metal housing 221. Referring to FIG. 6 and FIG. 7, each of the connecting units 222 include: a first connecting subunit 2221, forming a conductor under the action of the first magnetic field, a first electrode 211 of the power supply 21 being electrically connected to the first connecting subunit 2221, and the first connecting subunit 2221 being in contact electrical connection with the first power supply interface 11; and a second connecting subunit 2222, forming a conductor under the action of the second magnetic field, a second electrode 212 of the power supply 21 being electrically connected to the second connecting subunit 2222, and the second connecting subunit 2222 being in contact electrical connection with the second power supply interface 12. Alternatively, the metal housing 221 is made of iron or stainless steel. It should be understood that the material of the metal housing 221 is not limited to materials of iron or stainless steel described above, but may be other materials, which are not limited herein.

The operating principle of the charging system according to an embodiment is as follows.

In the charging system according to an embodiment, when the mobile terminal 10 is not placed on the charging base 20, that is, when the charging base 20 is not charging the mobile terminal 10, the first connecting subunit 2221 included in the connecting unit 222 is not affected by the first magnetic field of the first power supply interface 11, and the first connecting subunit 2221 is in an insulated state, that is, neither the first electrode 211 of the power supply nor the first power supply interface 11 is electrically connected to the first connecting subunit 2221. Similarly, the second connecting subunit 2222 included in the connecting unit 222 is also not affected by the second magnetic field of the second power supply interface 12, and the second connecting subunit 2222 is in an insulated state, that is, neither the second electrode 212 of the power supply 21 nor the second power supply interface 12 is electrically connected to the second connecting subunit 2222.

When the mobile terminal 10 is placed on the charging base 20, that is, when the charging base 20 is capable of charging the mobile terminal 10, the first power supply interface 11 of the mobile terminal 10 may be in contact with the first connecting subunit 2221 included in any connecting unit 222 on the charging base 20. Corresponding first connecting subunit 2221 forms a conductor under the action of the first magnetic field of the first power supply interface 11, so as to make the first electrode 211 of the power supply 21 of the charging base 20 electrically connected to the first connecting subunit 2221. The first connecting subunit 2221 is in contact electrical connection with the first power supply interface 11 of the mobile terminal 10, that is, the surface of the charging plate 22 is in contact electrical connection with the first power supply interface 11 of the mobile terminal 10.

Meanwhile, the second power supply interface 12 of the mobile terminal 10 is in contact with the second connecting subunit 2222 included in any connecting unit 222 on the charging base 20. Corresponding second connecting subunit 2222 forms a conductor under the action of the second magnetic field of the second power supply interface 12, so as to make the second electrode 212 of the power supply 21 of the charging base 20 electrically connected to the second connecting subunit 2222. The second connecting subunit 2222 is in contact electrical connection with the second power supply interface 12 of the mobile terminal 10, that is, the surface of the charging plate 22 is in contact electrical connection with the second power supply interface 12 of the mobile terminal 10, thereby forming a complete current loop. According to an embodiment, the current is directly transmitted using a conductor-to-conductor contact electrical connection, so that the charging base 20 charges the mobile terminal 10, thereby reducing energy consumption and improving the efficiency of charging the mobile terminal 10 by the charging base 20.

Advantageous effects achieved by the charging system according to an embodiment are at least as follows:

(1) according to an embodiment, the charging system use a conductor-to-conductor contact electrical connection to directly transmit current, in order to achieve charging of mobile terminal 10 by the charging base 20, reducing energy consumption, improving the efficiency of charging of mobile terminal 10 by the charging base 20, and improving charging speed, thus improving the user experience.

(2) according to the charging base, the mobile terminal 10 may be placed at any connecting unit 222 on the charging base 20, so as to implement effective charging of mobile terminal 10 by the charging base 20. The operation is convenient, and the charging efficiency is improved, thus improving the use experience of users.

(3) according to an embodiment, the charging system is simple in overall structure, convenient to charge, and low in cost.

Referring to FIG. 2, in an embodiment, the size of the first power interface 11 is not less than the size of the connecting unit 222. This ensures that the first power interface 11 is in good contact with the connecting unit 222.

In an embodiment, the size of the second power interface 12 is not less than the size of the connecting unit 222. This ensures that the second power interface 12 is in good contact with the connecting unit 222.

In an embodiment, the size of the first power interface 11 is not less than the size of the connecting unit 222, and the size of the second power interface 12 is not less than the size of the connecting unit 222. This ensures that the first power supply interface 11 and the second power supply interface 12 are in good contact with the connecting unit 222.

In an embodiment, a range value of a diameter of the first power interface 11 is 5-7 mm. Alternatively, the diameter of the first power supply interface 11 is 5 mm. In an embodiment, a range value of a diameter of the second power interface 12 is 5-7 mm. Alternatively, the diameter of the second power interface 12 is 5 mm. It should be understood that the diameter of the first power supply interface 11 and the diameter of the second power supply interface 12 are not limited to the above-mentioned cases, but may also be other cases, which are not limited herein.

In an embodiment, the diameter of the circumferential circle of the connecting unit 222 is 1-3 mm. Alternatively, the diameter of the circumferential circle of the connecting unit 222 is 1 mm. Alternatively, the diameter of the circumferential circle of the connecting unit 222 is 2 mm. Alternatively, the diameter of the circumferential circle of the connecting unit 222 is 3 mm. It should be understood that the size of the connecting unit 222 is not limited to the above-mentioned cases, but may also be other cases, and are not limited herein.

Referring to FIG. 2, in an embodiment, at least one of the first connecting subunits 2221 is in contact electrical connection with the first power interface 11. This ensures that the first power supply interface 11 is in good contact with the first connecting subunit 2221.

In an embodiment, at least one of the second connecting subunits 2222 is in contact electrical connection with the second power interface 12. This ensures that the second power supply interface 12 is in good contact with the second connecting subunit 2222.

In an embodiment, at least one of the first connecting subunits 2221 is in contact electrical connection with the first power interface 11, and at least one of the second connecting subunits 2222 is in contact electrical connection with the second power interface 12. This ensures that the first power supply interface 11 is in good contact with the first connecting subunit 2221, and the second power supply interface 12 is in good contact with the second connecting subunit 2222.

Alternatively, multiple first connecting subunits 2221 are electrically connected in contact with the first power supply interface 11, and multiple second connecting subunits 2222 are electrically connected in contact with the second power supply interface 12.

In an embodiment, referring to FIG. 7 and FIG. 8, the connecting unit 222 includes an accommodating lattice 2223 made of an insulating material, provided within the metal housing 221 and connected to the metal housing 221; and a dividing part 2224, provided within the accommodating space 2223 and dividing the accommodating space 2223 into a first accommodating region 22231 and a second accommodating region 22232. A first magnetic material 2225 is provided within the first accommodating region 22231. The first accommodating region 22231 and the first magnetic material 2225 define the first connecting subunit 2221. The first magnetic material 2225 is regularly arranged to form a conductor under the action of the first magnetic field of the first power supply interface 11. The first magnetic material 2225 is electrically connected to the first electrode 211 of the power supply 21. A second magnetic material 2226 is provided within the second accommodating region 22232. The second accommodating region 22232 and the second magnetic material 2226 define the second connecting subunit 2222. The second magnetic material 2226 is regularly arranged under the action of the second magnetic field of the second power supply interface 12 to form a conductor. The second magnetic material 2226 is electrically connected to the second electrode 212 of the power supply 21.

Each accommodating lattice 2223 is divided into two parts by the dividing part 2224 to form the first accommodating region 22231 and the second accommodating region 22232. The first magnetic material 2225 and the second magnetic material 2226 are provided within the first accommodating region 22231 and the second accommodating region 22232 respectively, so that the connecting unit 222 formed thereby is simple in structure. The first magnetic material 2225 is regularly arranged under the action of the first magnetic field generated by the first power supply interface 11 to form a conductor, making the first magnetic material 2225 electrically connected to the first electrode 211 of the power supply 21. The first magnetic material 2225 is in contact electrical connection with the first power supply interface 11 of the mobile terminal 10, that is, the surface of the charging plate 22 is in contact electrical connection with the first power supply interface 11 of the mobile terminal 10. Similarly, the second magnetic material 2226 is regularly arranged under the action of the second magnetic field generated by the second power supply interface 12 to form a conductor, making the second magnetic material 2226 electrically connected to the second electrode 212 of the power supply 21. The second magnetic material 2226 is in contact electrical connection with the second power supply interface 12 of the mobile terminal 10, that is, the surface of the charging plate 22 is in contact electrical connection with the second power supply interface 12 of the mobile terminal 10. A complete current loop is formed, thereby implementing the charge of the mobile terminal 10 by the charging base 20.

Alternatively, the material of the accommodating lattice 2223 is plastic. It should be understood that the material of the accommodating lattice 2223 is not limited to the material fo plastic described above, but may be other materials, which are not limited herein.

Alternatively, the material of the metal housing 221 may be iron or stainless steel. It should be understood that the material of the metal housing 221 is not limited to the material of the iron or stainless steel described above, but may be other materials, which are not limited herein.

Alternatively, the shapes and the sizes of the first accommodating region 22231 and the second accommodating region 22232 included in the accommodating lattice 2223 is same. In other embodiments, the shapes and the sizes of the first accommodating region 22231 and the accommodating lattice 22232 may be different.

Alternatively, the accommodating lattice 2223 is hexagonal in shape, and the first accommodating region 22231 and the second accommodating region 22232 are trapezoidal in shape. Alternatively, the accommodating lattice 2223 is circular in shape, and the first accommodating region 22231 and the second accommodating region 22232 are semi-circular in shape. Alternatively, the accommodating lattice 2223 is square in shape, and the first accommodating region 22231 and the second accommodating region 22232 are rectangular in shape. It should be understood that the shapes of the accommodating lattice 2223, the first accommodating region 22231, and the second accommodating region 22232 are not limited to the above-mentioned cases, but may also be other cases.

In an embodiment, referring to FIG. 4, multiple connecting units 222 are arranged throughout the metal housing 221. The multiple connecting units 222 are arranged in an array. Since the connecting units 222 are arranged throughout within the metal housing 221, the mobile terminal 10 can be placed at any position of the metal housing 221 to effectively charge the mobile terminal 10, thereby making the charging more convenient and improving user experience of users. It should be understood that multiple connection elements 222 are not limited to the array arrangement described above, but may be other arrangements, which are not limited herein.

In an embodiment, a first gap (not shown in the figure, the same below) is provided between adjacent connecting units 222. Alternatively, the range value of the first gap is 0.3-1 mm. Alternatively, the value of the first gap is 0.5 mm. It is to be understood that the first gap is not limited to above values, but may also be other cases, which is not limited herein.

In an embodiment, referring to FIG. 3, the first power supply interface 11 and the second power supply interface 12 are both provided in the middle of the battery cover 13, and a second gap 14 is provided between the first power supply interface 11 and the second power supply interface 12. The first power supply interface 11 and the second power supply interface 12 are both provided in the middle of the battery cover 13 to ensure that the first power supply interface 11 and the second power supply interface 12 are at a certain distance from the mobile terminal 10, thereby preventing exposure of the conductive area formed by the charging base 20 and preventing safety hazards. The second gap 14 is provided between the first power supply interface 11 and the second power supply interface 12 to prevent possible false triggering of a short circuit.

Alternatively, the second gap 14 is 8-12 times the diameter of the first power supply interface 11 or the second power supply interface 12. Alternatively, the second gap 14 is 10 times the diameter of the first power supply interface 11 or the second power supply interface 12.

Alternatively, the first electrode 211 is a positive electrode. The second electrode 212 is a negative electrode.

Alternatively, the first power supply interface 11 is a positive power supply interface and the first magnetic field generated is an S-pole magnetic field. The second power supply interface 12 is a negative power supply interface and the second magnetic field generated is an N-pole magnetic field.

Alternatively, the first magnetic material 2225 is a first magnetic sensitive diode made of a magnetic sensitive semiconductor. When there is no influence of a magnetic field, the holes and electrons in the magnetic sensitive semiconductor are in a balanced state, the internal current is very weak, appearing an insulator as a whole. When influenced by a forward magnetic field, for example, by the first magnetic field (S-pole magnetic field), the internal current of the magnetic sensitive semiconductor increases, exhibiting a conductor characteristic. When influenced by a reverse magnetic field, for example, by the second magnetic field (N-pole magnetic field), the internal current of the magnetic sensitive semiconductor further reduces, exhibiting an insulator characteristic as a whole. It should be understood that the forward magnetic field and the reverse magnetic field herein relate to the placement direction of the magnetic sensitive semiconductor.

Alternatively, the second magnetic material 2226 is a second magnetic sensitive diode made of a magnetic sensitive semiconductor, and unlike the first magnetic material, is oppositely provided with respect to the first magnetic material 2225 (magnetic sensitive diode). That is, when there is no influence of a magnetic field, the holes and electrons in the magnetic sensitive semiconductor are in a balanced state, and the internal current is very weak, appearing an insulator as a whole. When affected by a forward magnetic field, for example, by the second magnetic field (N-pole magnetic field), the internal current of the magnetic sensitive semiconductor is increased, exhibiting a conductor characteristic. When affected by a reverse magnetic field, for example, by the first magnetic field (S-pole magnetic field), the internal current of the magnetic sensitive semiconductor is further decreased, exhibiting an insulator characteristic as a whole.

### A Second Example

Referring to FIG. 4 and FIG. 5, according to an embodiment, a charging base 20 includes a power supply 21 and a charging plate 22. The charging plate 22 includes a metal housing 221, and multiple connecting units 222. The multiple connecting units 222 are all provided within the metal housing 221 and connected to the metal housing 221. Each of the connecting units 222 includes: a first connecting subunit 2221, forming a conductor under the action of an external first magnetic field, a first electrode 211 of the power supply 21 being electrically connected to the first connecting subunit 2221; and a second connecting subunit 2222, forming a conductor under the action of an external second magnetic field, the first electrode 211 of the power supply 21 being electrically connected to the second connecting subunit 2222. Alternatively, A material of the metal housing 221 may be iron or stainless steel. It should be understood that the material of the metal housing 221 is not limited to the material of iron or stainless steel described above, but may be other materials, which are not limited herein.

The operating principle of the charging base 20 according to an embodiment is as follows.

According to the charging base 20 according to an embodiment, when the charging base 20 is not charging the mobile terminal 10, that is, when the mobile terminal 10 is not placed on the charging base 20, the first connecting subunit 2221 included in the connecting unit 222 is not influenced by an external magnetic field. The first connecting subunit 2221 is in an insulated state and cannot conduct electricity, and no current is transmitted between the first electrode 211 of the power supply 21 and the first connecting subunit 2221. Similarly, the second connecting subunit 2222 included in the connecting unit 222 is not influenced by an external magnetic field, and the second connecting subunit 2222 is in an insulated state and can not conduct electricity, and no current is transmitted between the first electrode 211 of the power supply 21 and the second connecting subunit 2222.

When the charging base 20 is charging the mobile terminal 10, that is, when the mobile terminal 10 is placed on the charging base 20 and is in contact electrical connection between the charging base 20, the first connecting subunit 2221 included in the connecting unit 222 is influenced by an external magnetic field (a first magnetic field generated by the first power supply interface 11 of the mobile terminal 10). The first connecting subunit 2221 forms a conductor and is electrically connected to the first electrode 211 of the power supply 21, and can transmit current. Similarly, the second connecting subunit 2222 included in the connecting unit 222 is influenced by an external magnetic field (a second magnetic field generated by the second power supply interface 12 of the mobile terminal 10). The second connecting subunit 2222 forms a conductor and is electrically connected to the second electrode 212 of the power supply 21, and can transmit current, thereby implementing the charge of the mobile terminal 10.

Advantageous effects of the charging base 20 according to an embodiment are at least as follows:

(1) according to the charging base 20 according to an embodiment, the first connecting subunit 2221 and the second connecting subunit 2222 of the connecting unit 222 form conductors under the action of external magnetic fields, implementing electrical connections to the first electrode 211 and the second electrode 212 of the power supply 21 respectively. The external mobile terminal 10 is in contact electrical connection with the connecting unit 222, implementing the charge of the mobile terminal 10. A conductor-to-conductor contact electrical connection is used to directly transmit current, in order to implement charging of the mobile terminal 10 by the charging base 20, reducing energy consumption, improving the efficiency of charging of mobile terminal 10 by the charging base 20, and improving charging speed, thus improving the user experience.

(2) According to the charging base 20 according an embodiment, the mobile terminal 10 may be placed at a position of any connecting unit 222 on the charging base 20, so as to implement effective charging of the mobile terminal 10 by the charging base 20. The operation is convenient, and the charging efficiency is improved, thus improving the use experience of users.

(3) The charging base 20 according to an embodiment is simple in overall structure, convenient to charge, and low in cost.

In an embodiment, referring to FIG. 7 and FIG. 8, the connecting unit 222 includes an accommodating lattice 2223 made of an insulating material, provided within the metal housing 221 and connected to the metal housing 221; a dividing part 2224, provided within the accommodating lattice 2223 and dividing the accommodating lattice 2223 into a first accommodating region 22231 and a second accommodating region 22232. A first magnetic material 2225 is provided within the first accommodating region 22231. The first accommodating region 22231 and the first magnetic material 2225 define the first connecting subunit 2221. The first magnetic material 2225 is regularly arranged under the action of an external first magnetic field to form a conductor. The first magnetic material 2225 is electrically connected to the first electrode 211 of the power supply 21. A second magnetic material 2226 is provided within the second accommodating region 22232. The second accommodating region 22232 and the second magnetic material 2226 define the second connecting subunit 2222. The second magnetic material 2226 is regularly arranged under the action of an external second magnetic field to form a conductor. The second magnetic material 2226 is electrically connected to the second electrode 212 of the power supply 21.

Each accommodating lattice 2223 is divided into two parts by the dividing part 2224 to form the first accommodating region 22231 and the second accommodating region 22232. The first magnetic material 2225 and the second magnetic material 2226 are provided within the first accommodating region 22231 and the second accommodating region 22232, respectively, forming the connecting unit 222 simple in structure. The first magnetic material 2225 is regularly arranged under the action of the first magnetic field generated by the first power supply interface 11 to form a conductor, making the first magnetic material 2225 electrically connected to the first electrode 211 of the power supply 21. The first magnetic material 2225 is in contact electrical connection with the first power supply interface 11 of the mobile terminal 10, that is, the surface of the charging plate 22 is contact electrical connection with the first power supply interface 11 of the mobile terminal 10. Similarly, the second magnetic material 2226 is regularly arranged under the action of the second magnetic field generated by the second power supply interface 12 to form a conductor, making the second magnetic material 2226 electrically connected to the second electrode 212 of the power supply 21. The second magnetic material 2226 is in contact electrical connection with the second power supply interface 12 of the mobile terminal 10, that is, the surface of the charging plate 22 is in contact electrical connection with the second power supply interface 12 of the mobile terminal 10. A complete current loop is formed, implementing the charge of the mobile terminal 10 by the charging base 20.

Alternatively, the material of the housing 2223 is plastic. It should be understood that the material of the accommodating lattice 2223 is not limited to the material of plastic described above, but may be other materials, which are not limited herein.

In an embodiment, the diameter of circumferential circle of the connecting unit 222 is 1-3 mm. That is, the diameter of the circumferential circle of the accommodating lattice 2223 is 1-3 mm. Alternatively, the diameter of the circumferential circle of the connecting element 222 is 1 mm, that is, the diameter of the circumferential circle of the accommodating lattice 2223 is 1 mm. Alternatively, the diameter of the circumferential circle of the connecting element 222 is 2 mm, that is, the diameter of the circumferential circle of the accommodating lattice 2223 is 2 mm. Alternatively, the diameter of the circumferential circle of the connecting element 222 is 3 mm, that is, the diameter of the circumferential circle of the accommodating lattice 2223 is 3 mm. It should be understood that the size of the connecting unit 222 (the accommodating lattice 2223) is not limited to the above-described cases, but may be other cases, and are not limited herein.

In an embodiment, referring to FIG. 4, multiple connecting units 222 are arranged throughout the metal housing 221. The multiple connecting units 222 are arranged in an array. Since the connecting units 222 are arranged throughout within the metal housing 221, the mobile terminal 10 can be placed at any position of the metal housing 221 to effectively charge the mobile terminal 10, so that charging is more convenient and use experience of users is improved. It should be understood that multiple connection elements 222 are not limited to the array arrangement described above, but may be other arrangements, which are not limited herein.

In an embodiment, a first gap is provided between adjacent connecting elements 222.

Alternatively, the range value of the first gap is 0.3-1 mm. Alternatively, the first gap value is 0.5 mm. It should be understood that the first gap is not limited to the above-mentioned cases, but may also be other cases, and is not limited herein.

Alternatively, the first electrode 211 of the power supply 21 is a positive electrode. The second electrode 212 of the power supply 21 is a negative electrode.

Alternatively, the first magnetic material 2225 is a first magnetic sensitive diode made of a magnetic sensitive semiconductor. When there is no influence of a magnetic field, the holes and electrons in the magnetic sensitive semiconductor are in a balanced state. The internal current is very weak, appearing an insulator as a whole. When affected by a forward magnetic field, for example, by the first magnetic field (S-pole magnetic field), the internal current of the magnetic sensitive semiconductor increases, exhibiting a conductor characteristic. When affected by a reverse magnetic field, for example, by the second magnetic field (N-pole magnetic field), the internal current of the magnetic sensitive semiconductor further decreases, exhibiting an insulator characteristic as a whole. It should be understood that the forward magnetic field and the reverse magnetic field herein relate to the placement direction of the magnetic sensitive semiconductor.

Alternatively, the second magnetic material 2226 is a second magnetic sensitive diode made of a magnetic sensitive semiconductor, and unlike the first magnetic material, is oppositely provided with respect to the first magnetic material 2225 (magnetic sensitive diode). That is, when there is no influence of a magnetic field, the holes and electrons in the magnetic sensitive semiconductor are in a balanced state, and the internal current is very weak, appearing an insulator as a whole. When affected by a forward magnetic field, for example, by the second magnetic field (N-pole magnetic field), the internal current of the magnetic sensitive semiconductor increases, exhibiting a conductor characteristic. When affected by a reverse magnetic field, for example, by the first magnetic field (S-pole magnetic field), the internal current of the magnetic sensitive semiconductor further decreases, exhibiting an insulator characteristic as a whole.

### A Third Example

Referring to FIG. 3, further according to an embodiment, a mobile terminal 10 includes a battery cover 13; a first power supply interface 11 made of a magnetic material, electrically connected to the battery cover 13, and capable of generating a first magnetic field; and a second power supply interface 12 made of a magnetic material, electrically connected to the battery cover 13, and capable of generating a second magnetic field.

The operation principle of the mobile terminal 10 according to an embodiment is as follows.

According to the mobile terminal 10 according to an embodiment, the first power supply interface 11 and the second power supply interface 12 are electrically connected to the battery cover 13 and can transmit current. The first power supply interface 11 and the second power supply interface 12 are both made of a magnetic material. When the first power supply interface 11 and the second power supply interface 12 are in contact connection with a surface of the charging base 20, a first magnetic field generated by the first power supply interface 11 causes a first connecting subunit 2221 included in a connecting unit 222 to form a conductor, thereby implementing a contact electrical connection. Similarly, a second magnetic field generated by the second power supply interface 12 causes a second connecting subunit 2222 included in the connecting unit 222 to form a conductor, thereby implementing a contact electrical connection. Thus a current transmission is implemented between the charging base 20 and the mobile terminal 10, implementing charging of the mobile terminal 10.

Advantageous effects achieved by the mobile terminal 10 of an embodiment include at least:

(1) According to the mobile terminal 10 according to an embodiment, the first power supply interface 11 and the second power supply interface 12 are configured to be in contact connection with the charging base 20. The first power supply interface 11 and the second power supply interface 12 generate the first magnetic field and the second magnetic field respectively, so that the connecting unit 222 in the charging base 20 becomes a conductor, thereby implementing the first power supply interface 11 and the second power supply interface 12 being in contact electrical connection with the charging base 20. The electrical connection is implemented by a conductor-to-conductor contact, thereby realizing current transmission, reducing energy consumption, improving efficiency of charging the mobile terminal 10 by the charging base 20, improving charging speed, thus improving use experience of users.

(2) The mobile terminal 10 according an embodiment may be placed at a position of any connecting unit 222 on the charging base 20, so as to implement effective charging of the mobile terminal 10 by the charging base 20. The operation is convenient, and the charging efficiency is improved, thus improving the use experience of users.

(3) The mobile terminal 10 according to an embodiment is simple in overall structure, convenient to charge, and low in cost.

In an embodiment, a range value of a diameter of the first power interface 11 is 5-7 mm. Alternatively, the diameter of the first power supply interface 11 is 5 mm. In an embodiment, a range value of a diameter of the second power interface 12 is 5-7 mm. Alternatively, the diameter of the second power interface 12 is 5 mm. It should be understood that the diameter of the first power supply interface 11 and the diameter of the second power supply interface 12 are not limited to the above-mentioned cases, but may also be other cases, which are not limited herein.

In an embodiment, referring to FIG. 3, the first power supply interface 11 and the second power supply interface 12 are both provided in the middle of the battery cover 13, and a second gap 14 is provided between the first power supply interface 11 and the second power supply interface 12. The first power supply interface 11 and the second power supply interface 12 are both provided in the middle of the battery cover 13 to ensure that the first power supply interface 11 and the second power supply interface 12 are at a certain distance from the mobile terminal 10, thereby preventing exposure of a conductive area formed by the charging base 20 and preventing safety hazards. The second gap 14 is provided between the first power supply interface 11 and the second power supply interface 12 to prevent possible false triggering of a short circuit.

Alternatively, the second gap 14 is 8-12 times the diameter of the first power supply interface 11 or the second power supply interface 12. Alternatively, the second gap 14 is 10 times the diameter of the first power supply interface 11 or the second power supply interface 12.

Alternatively, the first power supply interface 11 is a positive power supply interface and the first magnetic field generated is an S-pole magnetic field. The second power supply interface 12 is a negative power supply interface and the second magnetic field generated is an N-pole magnetic field.

The foregoing description is merely exemplary embodiments of the present disclosure, and is not intended to limit the present disclosure. Any modifications, equivalents, and improvements that fall within the spirit and principle of the present disclosure are intended to be included within the scope of the present disclosure.

What is claimed is:

1. A charging base, comprising a power supply and a charging plate, wherein the charging plate comprises:
a metal housing; and
a plurality of connecting units all provided within the metal housing and connected to the metal housing,
wherein each of the plurality of connecting units comprises:
an accommodating lattice made of an insulating material, provided within and connected to the metal housing; and
a dividing part provided within the accommodating lattice, wherein the dividing part divides the accommodating lattice into a first accommodating region and a second accommodating region,
wherein a first magnetic material is provided within the first accommodating region, the first accommodating region and the first magnetic material define a first connecting subunit, the first magnetic material is regularly arranged under an action of an external first magnetic field to form a conductor, the first magnetic material is electrically connected to a first electrode of the power supply,
a second magnetic material is provided within the second accommodating region, the second accommodating region and the second magnetic material define a second connecting subunit, the second magnetic material is regularly arranged to form a conductor under an action of an external second magnetic field, and the second magnetic material is electrically connected to a second electrode of the power supply.

2. The charging base according to claim 1, wherein the metal housing is made of iron or stainless steel.

3. The charging base according to claim 1, wherein a diameter of a circumferential circle of the connecting unit is 1-3 mm.

4. The charging base according to claim 1, wherein the plurality of the connecting units are arranged throughout the metal housing, and a first gap is provided between adjacent connecting units.

5. The charging base of claim 4, wherein a width of the first gap is 0.3-1 mm.

6. The charging base according to claim 3, wherein the diameter of the circumferential circle of the connecting unit is 2 mm.

7. A mobile terminal, comprising:
a battery cover;
a first power supply interface made of a magnetic material, electrically connected to the battery cover, capable of generating a first magnetic field; and
a second power supply interface made of a magnetic material, electrically connected to the battery cover, capable of generating a second magnetic field.

8. The mobile terminal according to claim 7, wherein a range value of a diameter of the first power interface is 5 mm-7 mm; and/or
a range value of a diameter of the second power interface is 5 mm-7 mm.

9. The mobile terminal according to claim 8, wherein the diameter of the first power interface is 5 mm, and the diameter of the second power supply interface is 5 mm.

10. The mobile terminal according to claim 7, wherein the first power supply interface and the second power supply interface are both provided in middle of the battery cover, and a second gap is provided between the first power supply interface and the second power supply interface.

11. The mobile terminal according to claim 10, wherein the second gap is 8 to 12 times the diameter of the first power interface or the second power interface.

12. The mobile terminal of claim 11, wherein the second gap is 10 times the diameter of the first power interface or the second power interface.

13. A charging system, comprising a mobile terminal and a charging base, wherein the mobile terminal comprises:
a battery cover;
a first power supply interface made of a magnetic material, electrically connected to the battery cover, and capable of generating a first magnetic field; and
a second power interface made of a magnetic material, electrically connected to the battery cover, and capable of generating a second magnetic field;
wherein the charging base comprises a power supply and a charging plate,
wherein the charging plate comprises:
a metal housing; and
a plurality of connecting units all provided within the metal housing and connected to the metal housing,
wherein each of the plurality of connecting units comprises:
an accommodating lattice made of an insulating material, provided within and connected to the metal housing; and
a dividing part provided within the accommodating lattice, wherein the dividing part divides the accommodating lattice into a first accommodating region and a second accommodating region,
wherein a first magnetic material is provided within the first accommodating region, the first accommodating region and the first magnetic material define a first connecting subunit, the first magnetic material is regularly arranged under an action of an external first magnetic field to form a conductor, the first magnetic material is electrically connected to a first electrode of the power supply,
a second magnetic material is provided within the second accommodating region, the second accommodating region and the second magnetic material define a second connecting subunit, the second magnetic material is regularly arranged to form a conductor under an action of an external second magnetic field, and the second magnetic material is electrically connected to a second electrode of the power supply.

14. The charging system according to claim 13, wherein a size of the first power supply interface is larger than a size of the connecting unit;
and/or a size of the second power interface is larger than the size of the connecting unit.

15. The charging system of claim 14, wherein a range value of a diameter the first power supply interface is 5-7 mm;
and/or, a range value of a diameter of the second power interface is 5-7 mm.

16. The charging system according to claim 13, wherein at least one of the first connecting subunits is in contact electrical connection with the first power interface;
and/or at least one of the second connecting subunits is in contact electrical connection with the second power interface.

17. The charging system according to claim 14, wherein at least one of the first connecting subunits is in contact electrical connection with the first power interface;
and/or at least one of the second connecting subunits is in contact electrical connection with the second power interface.

18. The charging system according to claim 13, wherein a material of the metal housing is iron or stainless steel.

19. The charging system according to claim 13, wherein a diameter of a circumferential circle of the connecting unit is 1-3 mm.

20. The charging system according to claim 13, wherein the plurality of the connecting units are arranged throughout the metal housing, and a first gap is provided between adjacent connecting units.
